(19) United States
(12) Patent Application Publication
(10) Pub. No.: US 2021/0122369 A1
(43) Pub. Date: Apr. 29, 2021

(54) EXTENSIVIEW AND ADAPTIVE LKA FOR ADAS AND AUTONOMOUS DRIVING

(71) Applicant: INTELLIGENT COMMUTE LLC, Novi, MI (US)

(72) Inventor: Xuefei CHEN, Novi, MI (US)

(21) Appl. No.: 16/972,067

(22) PCT Filed: Jun. 25, 2019
(86) PCT No.: PCT/US2019/039048

§ 371 Date: Dec. 4, 2020

Related U.S. Application Data
(60) Provisional application No. 62/689,624, filed on Jun. 25, 2018.

(51) Int. Cl. B60W 30/12; B60W 30/095; G08G 1/16

(52) U.S. Cl. CPC B60W 30/12; B60W 30/0956; B60W 2420/52; B60W 2420/42; G08G 1/167

(57) ABSTRACT

A system and method for assisted driving include an extensive view sensor and an adaptive lane keeping assistant to detect traffic information in front of a leading vehicle based upon sensors mounted on sides of a host vehicle. The sensors may be cameras, radars, or LiDAR units. The sensors are side placed so that they can minimize the blocked view area. In order to achieve better view of the traffic in front of the leading vehicle, aLKA is also presented to adjust the lateral position of the host vehicle relative to the leading vehicle. Based on the detected information, the host vehicle can predict the traffic changes and prepare ahead of time.

### TECHNICAL FIELD

The present disclosure relates to advanced driver assistance systems, and more particularly to lane keeping assistant technology.

### BACKGROUND

Advanced driver-assistance systems (ADAS) are designed to reduce accident rates and make driving safer by aiding a human driver in driving. A few well-known ADAS in production include forward collision warning (FCW), automatic emergency brake (AEB), adaptive cruise control (ACC). Many current ADAS utilize a center mounted camera (e.g., Mobileye) and/or a radar sensor to detect and track objects in front of the vehicle, enabling the ADAS to give warnings or to control the vehicle to slow down or stop once a collision threat is detected.

FIGS. 1 and 2 illustrate that, much like human drivers, these center-mounted sensors may have a blocked view and/or blind zone 4 when there is a leading vehicle. The blind zone 4 can result in missed-detection, missed-tracking, or late-detection of potentially threatening objects or events. As illustrated in FIG. 1, the blind zone may cover the entire area of the lane in which the host vehicle 1 and the leading vehicle 2 are located, in front of the leading vehicle 2. The blind zone 4 may also include areas of other lanes in front of the leading vehicle 2. FIG. 2 illustrates how damaging the blind zone 4 can be to the efficacy of the sensors: an oncoming vehicle, a stopped vehicle, and a bicycle located in three different lanes are all within the blind zone 4. An example of the damage that may be caused by the blind zone 4 is a series collision. If a leading vehicle hits its brakes hard, since the view of the following vehicles are blocked, human drivers and/or ADAS controlling the following vehicles may not have enough warning time to respond to the sudden deceleration of the leading vehicle and any subsequent traffic. Note that ADAS also require a minimum time for responding. Another example of the limitations of current systems is potentially unsafe passing, as shown in FIG. 2. Since the view of the center-mounted sensor is blocked by the leading vehicle, the following vehicle is not aware of the traffic in the next lanes and that it is unsafe to pass the leading vehicle.

### SUMMARY

The present disclosure presents an imaging technology called Extensiview and an adaptive lane keeping assistant (aLKA) which incorporates Extensiview. The technology disclosed herein helps a host vehicle to detect the traffic in front of a leading vehicle through side mounted sensors, which minimize or eliminate the blind zone of the host vehicle, as shown in FIG. 1. Therefore, based on the detection and tracking information, the host vehicle is able to predict the upcoming traffic conditions, which gives the host vehicle potentially crucial extra time to prepare for responding to any sudden or hidden traffic changes. As a result, this technology is able to improve driving safety, driving comfort, and potentially fuel economy.

An exemplary embodiment of the system includes sensors placed on both sides of a host vehicle. The side-placed sensors may be cameras, radar units, or light detection and ranging (LiDAR) units. FIG. 3 shows the difference in field of view (FOV) between side-placed sensors and center-mounted sensors. Sensors placed on both sides of a vehicle can cover more blind view areas. The present disclosure focuses on using surround-view side cameras, which may be installed underneath the rear-view mirrors of a vehicle. If a surround-view camera system has been implemented on a vehicle, the presently disclosed technology may be applied without adding extra camera hardware and without significant additional cost. FIG. 4 shows the FOV of exemplary surround-view side cameras. Note that the surround-view side cameras used in this example are wide-angle or fisheye cameras, but that other types and configurations may be used in alternate embodiments.

This exemplary embodiment also includes a vehicle lane keeping algorithm. Traditional lane keeping assist (LKA) systems utilize the lane sensing result to keep a vehicle within a lane. Most of the time, the goal of traditional LKA systems is to keep the vehicle close to the lane center. As discussed above, the lane keeping method presented in this disclosure is called adaptive lane keeping assistant (aLKA). In order to cover more of the blocked view with side-camera extensive views (e.g., Extensiview), it is desirable to adaptively position the host vehicle off-center of the leading vehicle, but still keep within the lane to maintain safety. FIG. 5 illustrates the benefit of aLKA for minimizing blind zones.

As soon as side sensors detect an object, the perception algorithm will classify the object, and calculate the distance of the object from the vehicle, and calculate the velocity of the object. If the object is a vehicle, especially a leading vehicle, the perception algorithm can also detect illuminated brake lights, which can be a critical indication of imminent traffic speed change. The detected information will be sent to a vehicle controller so that the host vehicle can predict the coming traffic. The detected information can be displayed on an infotainment screen as a method of reminding drivers. The predicted information can be integrated with an AEB system for safety handling or integrated with a vehicle powertrain system to optimize the power output. As a result, the aLKA and the Extensiview system may not only improve driving safety, but may also improve driving comfort and potentially improve vehicle energy efficiency.

A system and method for assisted driving include an Extensiview sensor and an aLKA to detect traffic information in front of a leading vehicle based upon sensors mounted on sides of a host vehicle. The sensors may be cameras, radar sensors, or LiDAR units. The sensors are side placed so that they can minimize the blocked view area. In order to achieve a better view of the traffic in front of the leading vehicle, an aLKA is presented to adjust the lateral position of the host vehicle relative to the leading vehicle. Based on the detected information, the host vehicle can predict the traffic changes and prepare ahead of time.

### BRIEF DESCRIPTION OF THE DRAWINGS

FIG. 1 is a schematic diagram illustrating a traditional host vehicle's field of view and a view/zone blocked by a leading vehicle or obstacle. Here, \textcircled{1} is the host vehicle, \textcircled{2} is the leading vehicle or obstacle, \textcircled{3} is a normal field of view of the host vehicle if there were no obstruction, and \textcircled{4} is a blocked view/zone of the host vehicle caused by the leading vehicle or obstacle.

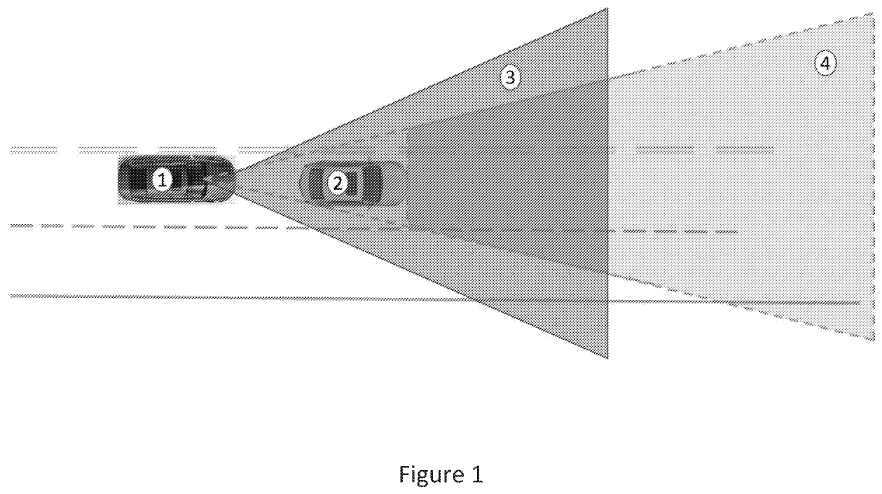

FIG. 2 is a schematic diagram showing that traditional technology may have a large blocked view which increases the chance of accidents, such as series collisions, unsafe passes, or the like. Here, \textcircled{1} is the host vehicle, \textcircled{2} is a normal field of view of the host vehicle, \textcircled{3} is a blocked view/zone of the host vehicle, and \textcircled{4} represents traditionally uninformed passing trajectories of the host vehicle.

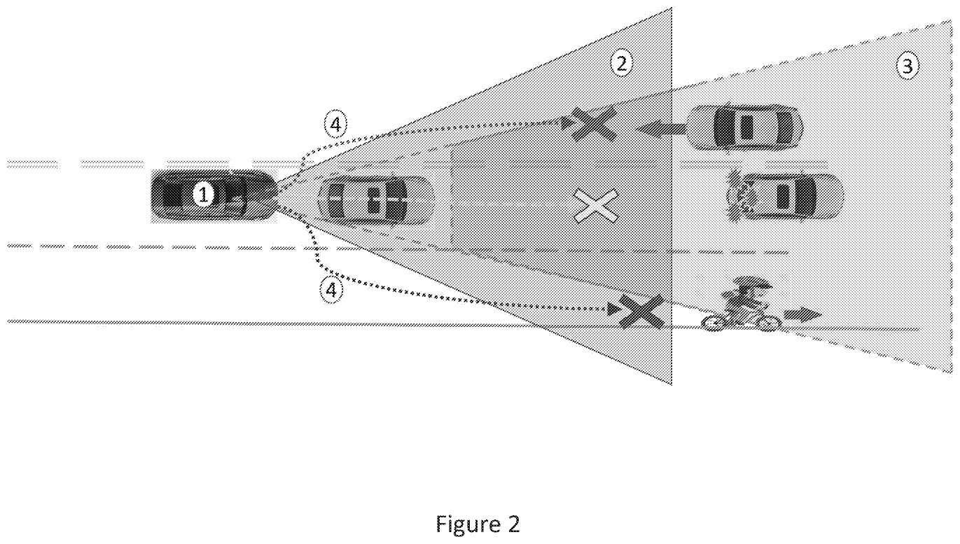

FIG. 3 is a schematic diagram illustrating a field of view (FOV) comparison between side-placed sensors and center-mounted sensors. Here, \textcircled{1} is the host vehicle, \textcircled{2} is a field of view of center-mounted sensors, \textcircled{3} is a field of view of side-placed sensors, and \textcircled{4} is a blocked view/zone of the center mounted sensors.

FIG. 4 is a schematic diagram showing a FOV of surround-view side cameras. Here, \textcircled{1} is the host vehicle, \textcircled{2} is a field of view of surround-view side cameras, \textcircled{3} is a field of view of center mounted sensors, and \textcircled{4} is a blocked view/zone of the center mounted sensors.

FIG. 5 is a schematic diagram demonstrating an application of an exemplary adaptive lane keeping assistant (aLKA) for minimizing blind zones on a straight road. Here, \textcircled{1} is the host vehicle, \textcircled{2} is the leading vehicle, \textcircled{3} is the vehicle to be detected, which is in front of the leading vehicle \textcircled{2}, \textcircled{4} is the center line of the leading vehicle, \textcircled{5} is a FOV of center-mounted sensors, and \textcircled{6} is a FOV of side-placed sensors.

FIG. 6 is a schematic diagram illustrating an application of an exemplary aLKA for maximizing the extensive view on curvy road. Here, \textcircled{1} is the host vehicle, \textcircled{2} is a FOV of center-mounted sensors, and \textcircled{3} is a FOV of side-placed sensors.

FIG. 7 is a photograph illustrating a test result comparison between surround-view side cameras versus surround-view center cameras and center roof-mounted cameras. Here, \textcircled{1} is a view from the surround-view center forward camera, \textcircled{2} is a view captured by front center roof mounted camera, \textcircled{3} is a view of the surround-view left side camera, \textcircled{4} is a view captured by the surround-view right side camera, \textcircled{5} and \textcircled{6} are the forward-looking like images converted (i.e., de-warped and projected) from parts of the images in \textcircled{3} and \textcircled{4}, and \textcircled{7} is a traditionally hidden vehicle.

FIG. 8 is a flowchart outlining an integrated Extensiview and aLKA system.

FIG. 9 is a photo demonstrating an exemplary test result of using Extensiview for object detection. Here, \textcircled{1} is the view from a center forward camera, \textcircled{2} and \textcircled{3} are the forward-looking like images converted from the images captured by surround-view side cameras. \textcircled{4} and \textcircled{5} outline the detected objects by surround-view side cameras, and \textcircled{6} highlights the vehicle in front of the leading vehicle, detected by the surround-view right side camera, where neither the front center camera nor the driver would be able to see it.

FIG. 10 is a schematic diagram illustrating the field of view of an exemplary Extensiview system.

### DETAILED DESCRIPTION

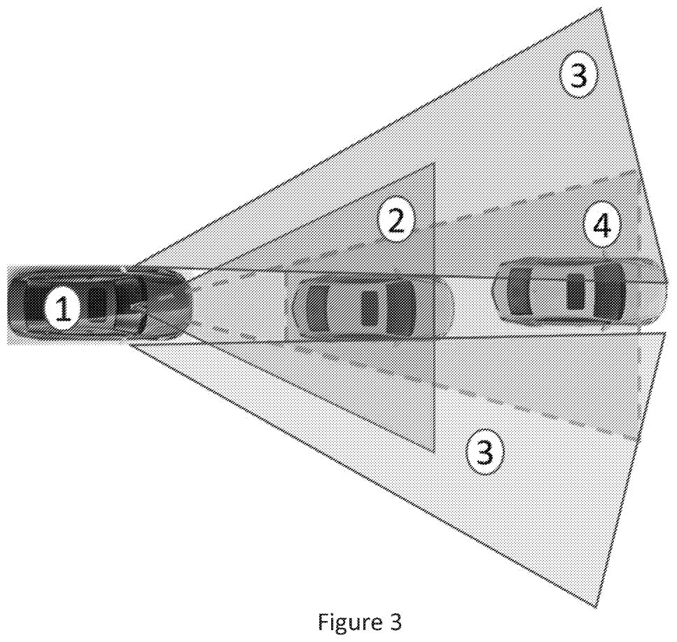

As discussed above, human drivers and center-mounted sensors controlling a host vehicle often have a relatively large blocked view/zone when the host vehicle is located behind a leading vehicle or obstacle. The present disclosure presents a vision technology called Extensiview and an aLKA incorporating Extensiview for minimizing the blocked zone and detecting the traffic in front of a leading vehicle. It should be noted that the vision technology disclosed herein is referred to as Extensiview; however, one skilled in the art will recognize that the systems and methods of the present disclosure may be implemented using any similar technology known in the art without departing from the scope of the disclosure. Instead of using center-mounted sensors, Extensiview may use sensors placed on both sides of a host vehicle, which, as shown in FIG. 3, are able to cover more blocked view areas so that more traffic information can be perceived. The traffic information may be vehicles, pedestrians, bicyclists, potholes or rocks on the road, or other obstacles present around the host vehicle. Also, the traffic information is not limited to the single lane where the host vehicle is driving, but may also include information about traffic in neighboring lanes, which is also important. For example, when a vehicle in the neighboring lane sees a big rock in his lane, that vehicle may have high probability of changing lanes, which, in turn, may affect the traffic flow of the lane where the host vehicle is driving. Such information is very useful in controlling the host vehicle, whether the host vehicle is a human driven vehicle or an autonomous vehicle. Based upon such information, the driver of the host vehicle, or the virtual driver or autonomous driving system of the host vehicle, may be provided an opportunity to predict the coming traffic change and prepare ahead of time.

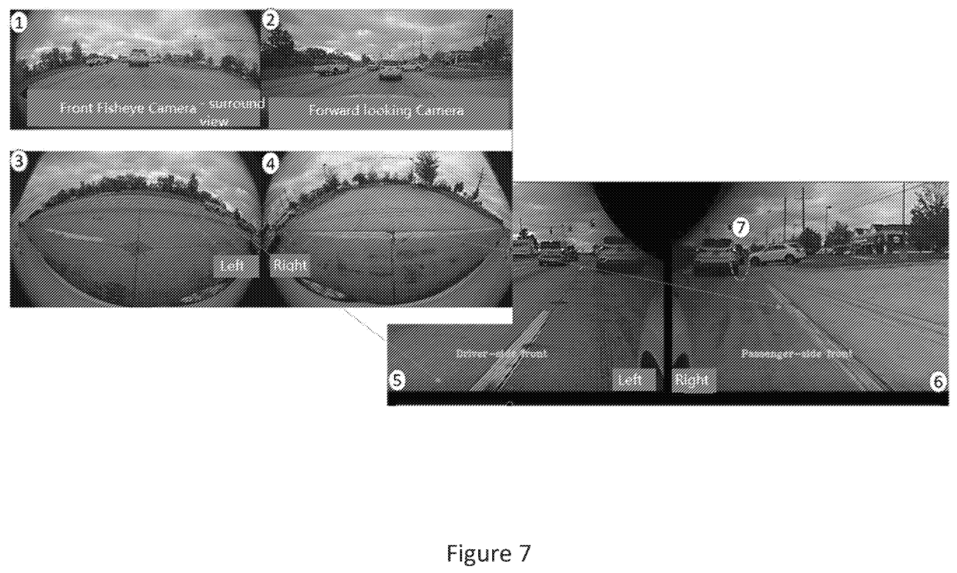

The sensors mounted on the host vehicle may be, but are not limited to, cameras, radars, or LiDAR units. The facing direction of the each of the sensors may be determined based on sensor characteristics. For example, a narrow field of view camera may be arranged to faceforward. A wide-angle camera, such as surround-view fisheye camera, may be arranged at an angle, such that it does not face forward. One of the possible benefits of using surround-view cameras is that it might allow a full view to be achieved without adding extra hardware parts and costs where such cameras are pre-installed. Another important benefit of using surround-view cameras is that the side downward facing surround-view cameras might not accumulate dirt as readily as outside-mounted forward-facing sensors. FIG. 7 illustrates a comparison between surround-view center cameras vs surround-view side cameras.

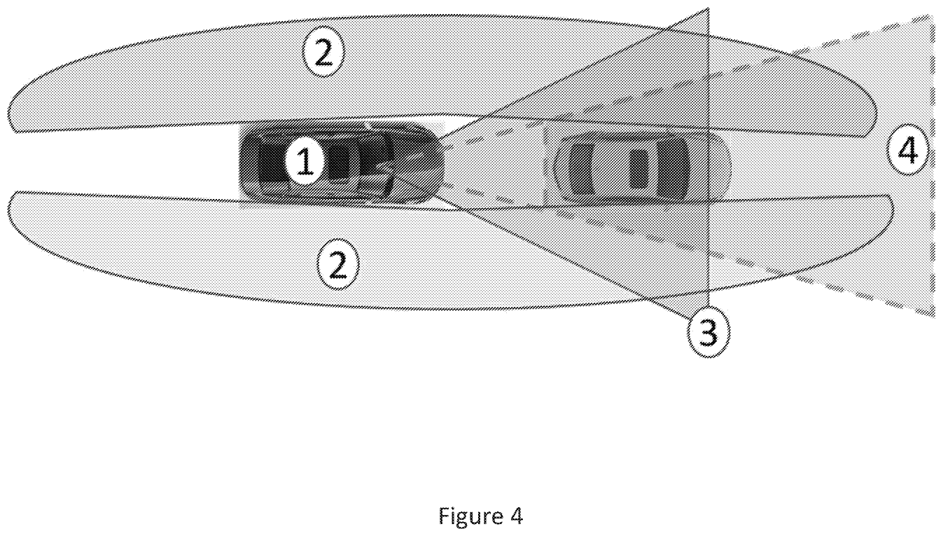

FIGS. 3 and 4 show schematic representations of the FOV of side mounted front-facing sensors and side mounted surround view sensors, respectively. As shown in FIG. 3, a front-facing camera mounted on the side of a host vehicle 1, may provide a FOV 3 extending in front of and to the side of the host vehicle 1. Unlike the FOV 2 of a center mounted sensor which may experience a blind zone 4, the FOV 3 of the side-mounted sensors may not be blocked by a leading vehicle. As shown in FIG. 3, a side mounted front facing sensor may be able to detect a vehicle in front of the leading vehicle, while a center mounted sensor may not be able to do so. As shown in FIG. 4, a surround view camera mounted on the side of a host vehicle 1 may provide a FOV 2 extending in front of, to the side of, and behind the host vehicle 1. These cameras may also not experience blind spots.

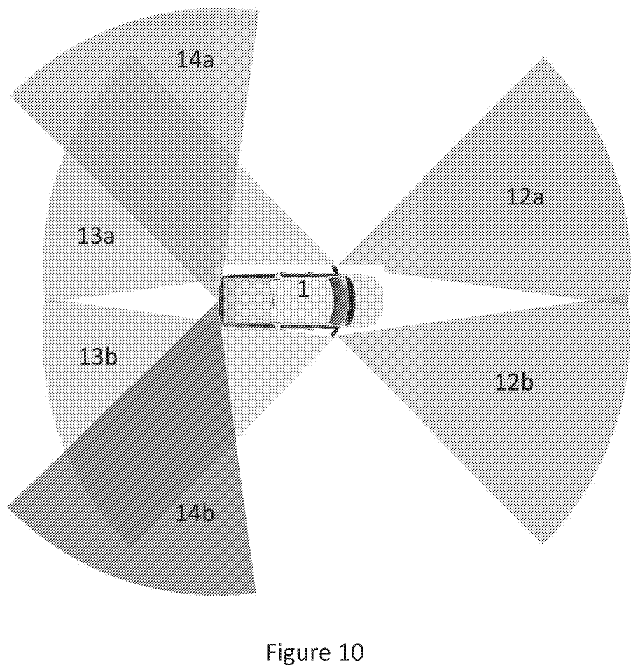

FIG. 10 shows a schematic representation of the FOV of a host vehicle 1 having multiple sensors mounted thereon. The host vehicle 1 may include two front facing cameras and two rear facing cameras mounted near its rear-view mirrors. The front facing cameras may have FOVs 12a, 12b which overlap at a point in front of the host vehicle 1. The rear facing cameras may have FOVs 13a, 13b which overlap at a point behind the host vehicle 1. These FOVs 13a, 13b may also cover regions to the sides of the host vehicle 1. The host vehicle 1 may have additional cameras mounted near the rear license plate which provide wider FOVs 14a, 14b in the area behind the vehicle, and may, for example, cover lanes to the side of the lane in which the host vehicle 1 is located.

In general, FIG. 10 shows that cameras or other sensors may be disposed around the host vehicle 1 to provide a complete overall FOV. In some embodiments, additional cameras or sensors may be added to the system to provide additional FOVs. In particular, sensors/cameras which are directed downwards or backwards may be used. The specific cameras/sensors used, and the positioning of those sensors may be determined based on the properties of the host vehicle 1 and the driving situations which it is likely to experience. In some embodiments, it may be possible to reposition the cameras/sensors on the host vehicle 1 and/or add cameras/sensor to a host vehicle 1 at different times while maintaining the same system controller.

In order to achieve a more extensive view of traffic in front of the host vehicle, a technology called adaptive lane keeping assistant (aLKA) is proposed in this disclosure. Traditional lane keeping assistants (LKA) may utilize lane sensing results for lateral control to keep the vehicle within the lane. Because the only goal of LKA is to keep the host vehicle within the lane, vehicles using LKA are usually maintained toward to lane center.

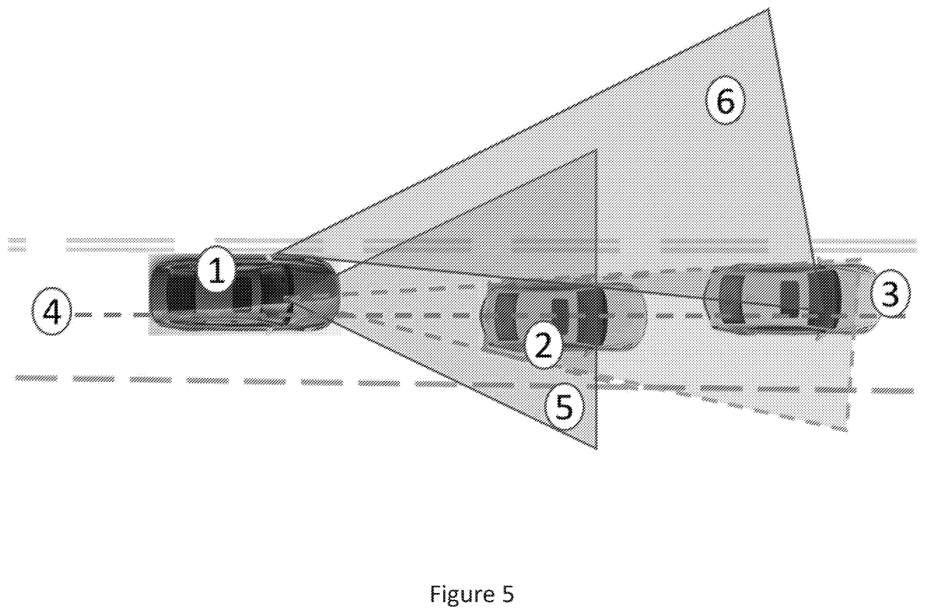

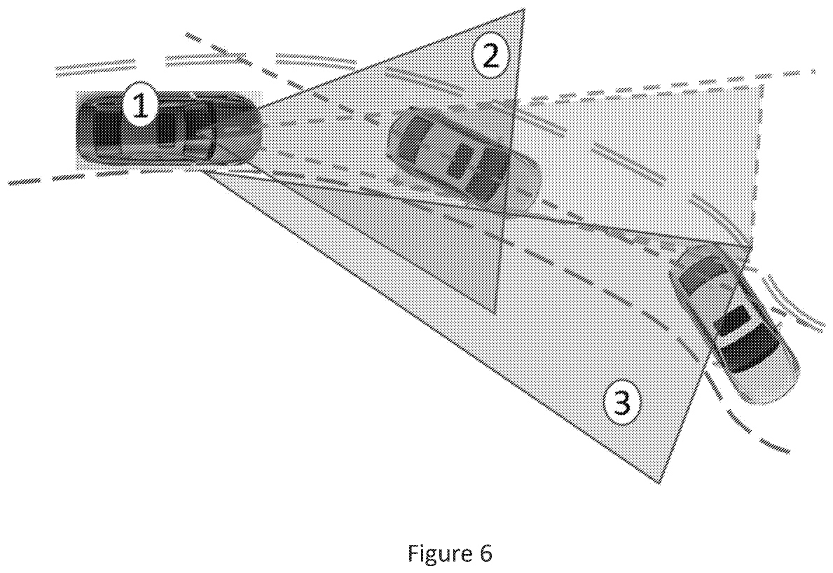

The goal of the aLKA of the present disclosure is not only to keep the host vehicle within the lane, but also to position the host vehicle toward the maximum safe and allowable side limit of the lane. The maximum allowable side limit may be determined based on the surrounding traffic conditions as well as the actual need. For example, if the leading vehicle has small width, aLKA may not need to position the vehicle near the lane marker. Or if there are vehicles nearby in the next lanes, then, the maximum allowable side limit may be smaller than the cases without vehicles in adjacent lanes. The decision about whether to position the host vehicle to the right or left side limit may depend on the position of a leading vehicle in the lane and/or the road curvature direction in curved road scenarios. In general, the aLKA may position the host vehicle off-center of the leading vehicle as much as needed to cover more center sensor or driver blocked view area with side mounted sensors' FOV. FIGS. 5 and 6 illustrate two use cases of applying aLKA for Extensiview. FIGS. 5 and 6 will be described in more detail below.

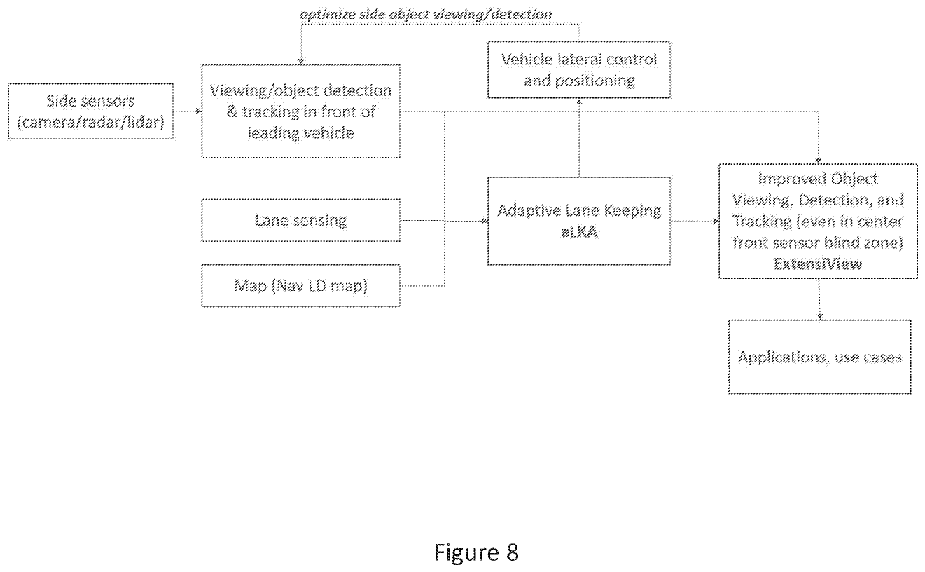

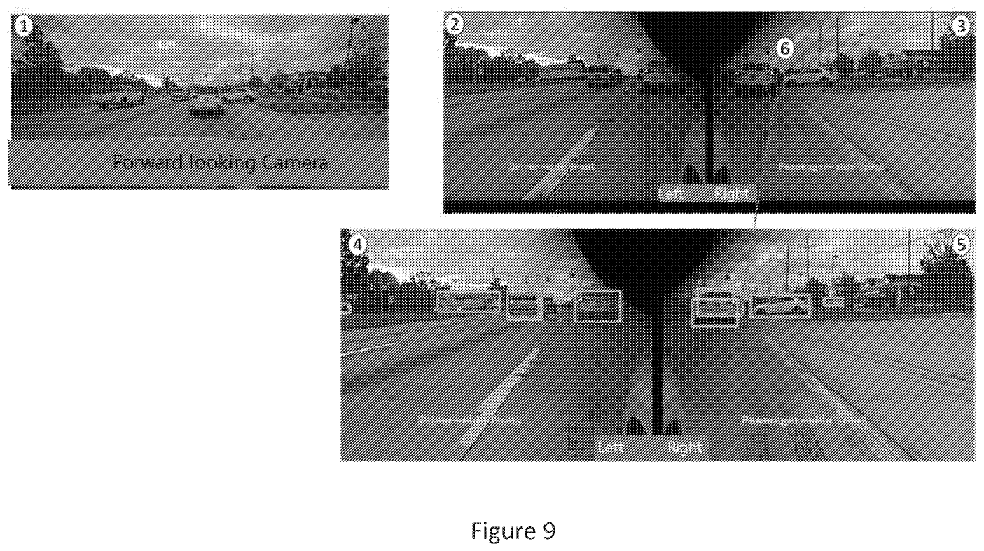

FIG. 8 shows the working flow chart of the Extensiview & aLKA system. The block of “side sensors” represents the side-placed sensors. The “viewing/object detection & tracking in front of leading vehicle” block represents the viewing feature or the perception algorithm of the system. The “lane sensing” block is to provide lane marker detection result for the lateral position of the host vehicle. The “MAP (Nav LD map)” is to provide the route information. For example, if the host vehicle knows the road is curvy, the aLKA can position the vehicle toward the inner lane marker to see a more extensive view for detection as shown in FIG. 6. The “Adaptive Lane Keeping” block calculates the desired lateral position of the host vehicle and sends it to the “Vehicle lateral control and positioning” block to actuate the vehicle to the desired position. As the result, the host vehicle adaptively adjusts its lateral position within the lane to cover more of the blocked view and improve object viewing, detection, and tracking. As soon as side-placed sensors detect any objects, the perception algorithm will classify the objects, and calculate the distances and the velocities of the objects using object tracking such as a KF filter. In addition, if the objects in front of the leading vehicle are vehicles, the algorithm is also able to identify the brake lights' status, and on the like. FIG. 7 and FIG. 9 show Extensiview using surround-view side cameras. It is clear from the right-side surround-view camera in FIG. 7 that there was a dark color SUV in front of the silver SUV. However, neither the front center surround-view camera nor the front center roof mounted camera was able to detect that dark SUV due to the blocked view. The extensive-view system can not only see that dark vehicle, but also detect that object as a vehicle.

Vehicle controllers using information from the Extensiview sensors may include two further functionalities: tracking and prediction. Tracking may be needed because the sensors may not be able to capture the object in front of the leading vehicle all time. When one object is occluded within the FOV of the sensor, it is necessary to continue tracking and estimating the trajectory of that object. Prediction is needed to predict the potential behavior of the leading vehicle. For example, when Extensiview captures that the car in front of the leading vehicle is braking, the prediction block, which resides in the host vehicle path planning and decision module, may calculate the probability of the leading vehicle slowing down or changing lanes, and estimate the potential trajectory of the leading vehicle. In some embodiments, the prediction block may determine multiple potential trajectories and determine a probability of each. The predicted information may then be provided to the host vehicle controller, so that vehicle controller can prepare in ahead of time.

There are multiple potential applications for the proposed Extensiview & aLKA system. In one exemplary embodiment, the proposed systems may be configured to work with an automatic emergency brake (AEB) system to improve vehicle safety. While traditional AEB systems only detect the leading vehicle, the Extensiview system can provide extensive traffic information beyond the leading vehicle, based upon which, the host vehicle can predict the change of the traffic conditions, and inform the AEB system to prepare to brake ahead of time. For example, if any front vehicle conducts a sudden hard brake, the Extensiview system may know quickly and notify the host vehicle controller to prepare for the coming sudden traffic deceleration. This information may be passed to the controller of the AEB system, thereby allowing it to activate the emergency brakes more quickly. In dangerous traffic situations, activating the brakes even a fraction of a second more quickly may prevent a collision.

In another exemplary embodiment, information collected by the proposed systems may be sent to a vehicle powertrain controller to optimize the power output. For instance, if any vehicle in front of the host vehicle is gradually slowing down or speeding up, the system may optimize the power output to improve the energy efficiency and driving comfort. The method of improving vehicle energy efficiency may include, but is not limited to, optimizing energy distribution between different energy sources, and/or optimizing the power output over a time period so that it can reduce radical acceleration or deceleration which is usually inefficient.

The traffic information collected by the proposed systems may also be displayed on the infotainment screen. The information to be displayed may include, but is not limited to, objects' distance from the host vehicle, objects' speed, objects' predicted trajectories, and other information. When there is any change of the traffic, such as, for example, when any front vehicle decelerates or any vehicle switches lanes, the system can alert the driver, thereby improving the driver's ability to make good decisions about accelerating, decelerating, changing lanes, or making other changes.

In alternate embodiments, Extensiview and aLKA systems may be used together or separately. It shall be understood that sensors not limited to cameras. Sensor installation location is not limited to the rearview mirrors, and can be in upper corners behind the windshield, for example, or any other places generally on the sides of the vehicle. The detected object is not limited to vehicles, but mat include any stationary, moveable or moving vehicle, object, person, animal, or the like. The adaptive nature of aLKA includes its adaptive control of vehicle position within a lane to enhance detection of otherwise blocked views. While an application incorporating AEB is described, alternate embodiments may incorporate any other vehicular sensors, systems and actuators. Control parameters of the system and method may be optionally weighted or selectable for improving vehicle energy efficiency, driving comfort, speed, preferential views, or the like. As described above, the system may incorporate a tracking feature to track objects which may become obscured at times, such as objects in front of a leading vehicle. The system may also incorporate a prediction feature to predict the behavior of a leading vehicle or other obstacle.

Exemplary implementations of the systems and methods disclosed herein are now described with reference to FIGS. 5 and 6. These Figures illustrate the function of an aLKA using Extensiview to minimize the blind zone experienced by a host vehicle when driving on a straight road and a curvy road, respectively.

FIG. 5 illustrates a host vehicle 1 outfitted with a sensor system, such as an Extensiview system. The sensor system may include a side sensor having an FOV 6 and optionally a center sensor having a FOV 5. The sensor system may include other sensors, included sensors which detect the positioning of the host vehicle 1 relative to the lane lines. The sensors may detect a front vehicle 2 in front of the host vehicle 1. As discussed above, the front vehicle 2 may cause blind zones in the FOVs 5, 6 of the sensors. The blind zones could prevent the sensors from detecting a secondary vehicle 3 in front of the front vehicle 2. The information collected by the sensor system may be transmitted to the aLKA, which may determine how the host vehicle 1 should be positioned within the lane. The aLKA may recognize that the front vehicle 2 causes the most significant blind zones when the front vehicle 2 is directly in front of the host vehicle 1 on a straight road. Accordingly, the aLKA may cause the host vehicle 1 to be positioned as far from directly behind the front vehicle 2 as possible while remaining within the lane. This may allow the sensor system to clearly detect the secondary vehicle 3. By keeping the secondary vehicle 3 in the FOV 5, 6 of at least one sensor, the aLKA may enable the host vehicle 1 to respond more quickly to actions of the secondary vehicle 3, such as decelerating or changing lanes. This may increase the safety of the host vehicle 1.

FIG. 6 illustrates a host vehicle 1 in a similar scenario on a curved road. In such a scenario, the aLKA may also consider information about the curvature of the road at the point where the host vehicle 1 is currently located and the curvature of the road in front of the host vehicle 1. The aLKA may act to keep the secondary vehicle in the FOV 3, 2 of one or more sensors. In some embodiments, the aLKA may account for vehicles in front of the secondary vehicle, vehicles behind the host vehicle, vehicles in other lanes, and/or obstacles other than vehicles.

The present disclosure has laid out numerous elements and capabilities which may characterize a vision and driving assist system. It should be noted that any elements may be combined with any other elements, even if not explicitly disclosed herein. Further, a system may not include elements disclosed herein, even if the element is described in combination with other elements.

1. An advanced drive assistant system for a vehicle comprising:
at least one sensor installed on a side of the vehicle, the sensor configured to detect objects in at least one blind zone of said vehicle's driver; and
an output interface to transmit a signal from said at least one sensor to said driver for the information of said at least one blind zone.

2. The system of claim 1, wherein said sensor is at least one of a: camera, a radar, or a LiDAR.

3. The system of claim 1, wherein the system comprises two sensors installed on both side of said vehicle.

4. The system of claim 1, wherein said blind zone is one of:
zones which are blocked by a leading vehicle in front of said vehicle; and
zones which are not covered by mirrors of said vehicle.

5. An adaptive lane keeping method usable while driving a vehicle, comprising:
positioning said vehicle within current lane; and
moving said vehicle aside in said lane and within a maximum allowable side limit so as to reduce a front blind zone of the vehicle's driver.

6. The method of claim 5, wherein said front blind zone is an area blocked by a leading vehicle.

7. The method of claim 5, wherein said front blind zone is at least one of:
an area undiscovered to a sensor installed on a side of said vehicle;
an area undiscovered to a sensor installed on a middle portion of said vehicle; or
an area undiscovered to said driver.

8. The method of claim 5, further comprising sweeping from one side to the other side within said maximum allowable side limit to minimize said blind zone.

9. The system of claim 1, wherein the blind zone is a portion of host vehicle's surroundings which is vehicle maneuver and driving safety which is not covered by the field of view of any of the at least one sensors or is blocked by an obstacle.

10. The system of claim 1, wherein the advanced drive assistant is configured to determine an optimal position of the vehicle within a lane based on the position of a leading vehicle.

11. The system of claim 10, wherein the optimal position minimizes the blind zone caused by the leading vehicle.

12. The system of claim 1, wherein the at least one sensor comprises a surround-view camera.

13. The system of claim 1, wherein the sensor comprises a camera configured to capture images from more than one region.

14. The system of claim 1, wherein the sensor is mounted within the vehicle, such that the sensor does not extend from the surface of the vehicle.

15. The method of claim 5, further comprising detecting one or more obstacles in front of the vehicle.

16. The method of claim 15, wherein positioning the vehicle within the lane comprises positioning the vehicle based on the one or more obstacles.

17. The method of claim 5, further comprising controlling a speed of the vehicle.

18. An advanced drive assistant system for a vehicle comprising:
at least one sensor installed on a side of the vehicle, the sensor configured to detect objects in at least one blind zone of said vehicle's driver; and
a controller configured to command the vehicle.

19. The system of claim 18, wherein commanding the vehicle comprises activating an automatic emergency brake system.

20. The system of claim 18, wherein commanding the vehicle comprises controlling an energy source of the vehicle.
